(19) United States
(12) Patent Application Publication
(10) Pub. No.: US 2025/0273105 A1
(43) Pub. Date: Aug. 28, 2025

(54) APPARATUS AND METHOD FOR DETERMINING STATUS OF FLEXIBLE DISPLAY

(71) Applicant: SAMSUNG ELECTRONICS CO., LTD., Suwon-si (KR)

(72) Inventors: Manjunath Vinay ARGEKAR, Noida (IN); Genemala Haobijam, Noida (IN)

(73) Assignee: SAMSUNG ELECTRONCIS CO., LTD., Suson-si (KR)

(21) Appl. No.: 19/205,556

(22) Filed: May 12, 2025

Related U.S. Application Data
(63) Continuation of application No. PCT/KR2023/010013, filed on Jul. 13, 2023.

(30) Foreign Application Priority Data
Nov. 17, 2022 (IN) 202241005896

(51) Int. Cl. G09G 3/00

(52) U.S. Cl. CPC G09G 3/006; G09G 3/035; G09G 2330/10

(57) ABSTRACT

A method for determining a status of a flexible display is provided. The method may include obtaining at least one baseline value of the flexible display. The method may include obtaining at least one raw value of flexible display. The method may include identifying a variation of the at least one raw value from the at least one baseline value. The method may include determining the status of the flexible display as having deformation based on the identified variation of the at least one raw value.

### CROSS-REFERENCE TO RELATED APPLICATIONS

This application is a continuation application of International Application No. PCT/KR2023/010013, filed on Jul. 13, 2023, which is based on and claims priority from Indian patent application Ser. No. 202241065896, filed on Nov. 17, 2022, the disclosures of which are herein incorporated by reference in their entireties.

### BACKGROUND

### 1. Field

The disclosure relates to a system and a method for determining a status of a flexible display. The disclosure particularly relates to detection of deformation of an affected pixel and applying a deformation compensation to the flexible display.

### 2. Description of Related Art

A display provide information as a visual representation and thus serve as an essential building block for visualizing data in electronics devices such as, for example, smartphones and laptops. Electronics fields have recently made progress towards provide a flexible, thin, lightweight, and/or wearable display such that the display may be bent, folded, and/or stretched without compromising performance. It is desirable to provide a flexible display that may be repeatedly and severely bent, flexed and/or folded during service.

A flexible panel includes a flexible backplane, a flexible display, and a flexible touch screen panel (TSP). The flexible backplane includes flexible materials. When a flexible panel is stretched or bent, different characteristics of the panel may change. The flexible touch screen panel has become a key element in various electronic devices such as televisions (TVs), hand-held devices, and laptops, and an increasing demand for a more interactive user interface has influenced broadening of a touch screen panel application area. There are different types of touch screen panels, and the most popular type are resistive and capacitive. The resistive type of the touch screen panel senses a resistance change caused by deformation of a touch screen panel film and the capacitive type of touch screen panel senses a capacitance change associated with disturbance of fringe electric fields due to a finger touch. A transition between a folded state and a planar state of the flexible display device causes a tension in the flexible display device, wherein the tension may act as a pushing force towards two sides of the panel when the flexible display device transitions from a planar state to a folded state. More particularly, a pulling force towards a folding area comes into action when the flexible display device is switched from the folded state to the planar state. The tension concentrated in the folding area of a flexible display screen causes some deformation, waving or warpage, and damage to internal components of the flexible display screen such as line breakage of a TFT (Thin Film Transistor), resulting in poor display.

Hence, there exists a need for detecting deformation on the screen and providing a visual compensation to reduce visibility of the deformation to a user.

### SUMMARY

In an aspect of an example embodiment, a method for determining a status of a flexible display is provided. The method may include obtaining at least one baseline value of the flexible display; obtaining at least one raw value of the flexible display; identifying a variation of the at least one raw value from the at least one baseline value; and determining the status of the flexible display as having deformation based on the identified variation of the at least one raw value.

In an aspect of an example embodiment, an apparatus for determining a status of a flexible display is provided. The apparatus may include a memory configured to store one or more instructions; and at least one processor configured to execute the one or more instructions to: obtain at least one baseline value of the flexible display; obtain at least one raw value of the flexible display; identify a variation of the at least one raw value from the at least one baseline value; and determine the status of the flexible display as having deformation based on the identified variation of the at least one raw value.

In an aspect of an example embodiment, a non-transitory computer-readable storage medium, storing one or more instructions executable by at least one processor to perform: obtaining at least one baseline value of the flexible display; obtaining at least one raw value of the flexible display; identifying a variation of the at least one raw value from the at least one baseline value; and determining the status of the flexible display as having deformation based on the identified variation of the at least one raw value.

### BRIEF DESCRIPTION OF DRAWINGS

The foregoing and other features of embodiments will become more apparent from the following detailed description of example embodiments when read in conjunction with the accompanying drawings. In the drawings, like reference numerals refer to like elements.

FIG. 1 illustrates a flowchart of a method for determining a status of a flexible display according to an embodiment of the disclosure.

FIG. 2 illustrates a flowchart of a method of determining a screen topology for determining a defect in affected one or more pixels according to an embodiment of the disclosure.

FIG. 3 illustrates a flowchart of a method of applying a deformation compensation according to an embodiment of the disclosure.

FIG. 4 illustrates a block diagram of a system for determining a status of a flexible screen according to an embodiment of the disclosure.

FIG. 5 illustrates a block diagram of a raw data acquisition module according to an embodiment of the disclosure.

FIG. 6 illustrates a block diagram of a screen deformation estimator unit according to an embodiment of the disclosure.

FIG. 7 illustrates an electronic display panel according to an embodiment of the disclosure.

FIG. 8 illustrates a block diagram of a screen-deformation correction unit according to an embodiment of the disclosure.

FIG. 9 illustrates a functional block diagram of a damage detection module according to an embodiment of the disclosure.

FIG. 10 illustrates a diagram showing an upper panel and a lower panel of a flexible screen display according to an embodiment of the disclosure.

FIGS. 11A and 11B illustrate examples of a non-deformed screen and a deformed screen.

FIG. 12 illustrates diagrams for describing operations of a flexible display according to an embodiment of the disclosure.

FIG. 13 illustrates an example of a use case of a flexible display according to an embodiment of the disclosure.

FIG. 14 illustrates a flow chart of a method for determining a status of a flexible display according to an embodiment of the disclosure.

FIG. 15 illustrates a block diagram of an apparatus for implementing an embodiment of the disclosure.

### DETAILED DESCRIPTION

Definitions of certain words and phrases used herein are set forth. The terms “transmit,” “receive,” and “communicate,” as well as derivatives thereof, encompass direct and/or indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below may be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate (1) at least one A, (2) at least one B, or (3) at least one A, and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of the disclosure.

It will be understood that, when an element (such as a first element) is referred to as being (operatively or communicatively) “coupled with/to” or “connected with/to” another element (such as a second element), it may be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device may perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of the disclosure but not to limit the scope of other embodiments of the disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of the disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of the disclosure.

Examples of an “apparatus” according to embodiments of the disclosure may include, for example but not limited to, at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch) including a flexible display. Note that, according to various embodiments of the disclosure, an apparatus may be one or a combination of the above-listed devices. According to some embodiments of the disclosure, the apparatus may be a flexible apparatus. The apparatus disclosed here is not limited to the above-listed devices and may include new apparatuses depending on the development of technology.

In the following description, apparatuses are described with reference to the accompanying drawings, according to various embodiments of the disclosure. As used here, the term “user” may denote a human or another device (such as an artificial intelligent electronic device) using the electronic device.

Definitions for other certain words and phrases may be provided throughout this specification. Those of ordinary skill in the art should understand that in many if not most instances, such definitions apply to prior as well as future uses of such defined words and phrases.

None of the description in this application should be read as implying that any particular element, step, or function is an essential element that must be included in the claim scope.

In an embodiment of the disclosure, at least one of a plurality of modules may be implemented through an artificial intelligence (AI) model. A function associated with AI may be performed through a non-volatile memory, a volatile memory, and/or a processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors may control processing of input data in accordance with a predefined operating rule or an artificial intelligence (AI) model stored in the non-volatile memory and/or the volatile memory. The predefined operating rule or the artificial intelligence model may be provided through training or learning. Here, being provided through learning means that, by applying a learning algorithm to a plurality of learning data, a predefined operating rule or an AI model of a desired characteristic is made. The learning may be performed in a device itself in which AI according to an embodiment is performed, and/or may be implemented through a separate server/system.

The AI model may include a plurality of neural network layers. Each layer may have a plurality of weight values and perform a layer operation through calculation of a previous layer and an operation of a plurality of weights. Examples of neural networks may include, for example but not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks. The learning algorithm may be used to train a predetermined target device (for example, a robot) using a plurality of learning data to cause, allow, or control the target device to make a determination or prediction. Examples of learning algorithms may include, for example but not limited to, supervised learning, unsupervised learning, semi-supervised learning, or reinforcement learning.

Reference will now be made in detail to the description of the present subject matter, one or more examples of which are shown in the figures. Each example is provided to explain the subject matter and not a limitation. Various changes and modifications obvious to one skilled in the art to which the disclosure pertains are deemed to be within the spirit, scope and contemplation of the disclosure.

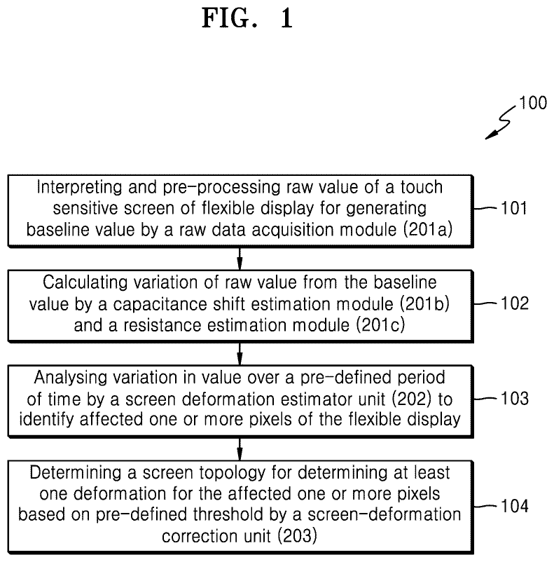

Referring now to FIG. 1, a flowchart of a method 100 for determining a status of a flexible display according to an embodiment of the disclosure is illustrated. The method 100 may comprise operation 101 of interpreting and pre-processing a raw value of a touch sensitive screen of a flexible display for generating a baseline value by a raw data acquisition module 201a. The flexible display may include, for example but not limited to, a flexible touch screen display.

In an embodiment of the disclosure, the raw value of the touch sensitive screen of the flexible display may be read by scanning electrodes, every time the flexible display is turned on. The raw value of the touch sensitive screen of the flexible display may include capacitance, inductance, and/or resistance values. Further, the raw data may be preprocessed to obtain clean data. More particularly, high frequency or unwanted signals may be removed from the raw data to obtain clean raw data. Furthermore, baseline values of capacitance, inductance, and/or resistance may be obtained from a storage of the touch screen display.

In operation 102, a variation of the raw value from a corresponding baseline value may be calculated by a capacitance shift estimation module 201b and a resistance estimation module 201c. In an embodiment of the disclosure, a variation of the capacitance, inductance and/or resistance value from the baseline value may arise due to a change in a mechanical property in a surface of the touch sensitive screen of the flexible display.

In operation 103, the variation in the capacitance, inductance and/or resistance value may be analyzed over a pre-defined period of time by a screen deformation estimator unit 202 to identify affected one or more pixels of the flexible display. In an embodiment of the disclosure, the change from the baseline capacitance and inductance values may be detected to analyze and estimate health of a pixel structure, a power profile of pixels, a flexible display screen, etc. and a user may be informed of the estimated health (e.g., potential failure of the screen).

In operation 104, a screen topology may be diagnosed (or analyzed or used) for determining at least one deformation for the affected one or more pixels based on a pre-defined threshold by a screen-deformation correction unit 203. In an embodiment of the disclosure, the screen topology may be diagnosed for determining an arc angle or valley formation across the surface of the touch sensitive screen of the flexible display for the affected one or more pixels. In an embodiment of the disclosure, the screen topology may be diagnosed for determining at least one of a deformation for bending detection/calculation, image inversion and a pixel defect for the identified affected one or more pixels.

In an embodiment of the disclosure, the affected one or more pixels may be determined to detect at least one of a point, an area or a zone for a number of pixels having a variation in the capacitance, inductance, and/or resistance value exceeding a predetermined threshold in comparison to a normal surface. The variation in the capacitance, inductance, and/or resistance value may be analyzed over a pre-defined period of time to identify one or more touch screen pixels that are affected without causing a visible change to the touch sensitive screen of the flexible display.

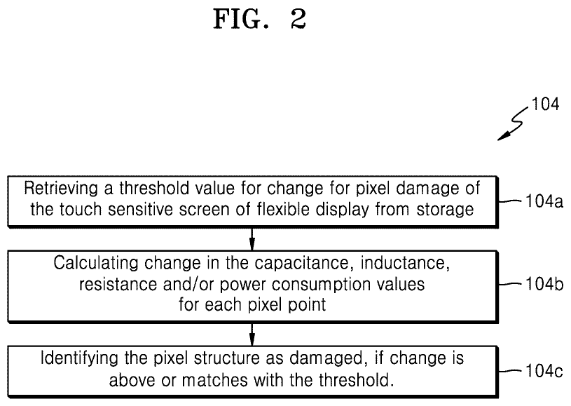

FIG. 2 illustrates a flowchart of a method 104 of diagnosing the screen topology for determining a defect in affected one or more pixels by the screen-deformation correction unit 203, according to an embodiment of the disclosure. The method 104 may comprise operations of retrieving a threshold value to be compared against for a change for a pixel damage of the touch sensitive screen of the flexible display from storage in operation 104a. In operation 104b, a change in the capacitance, inductance, resistance, and/or power consumption values for each pixel point may be calculated. Further, in operation 104c, the pixel structure may be identified as damaged if the change is above or matches with the pre-determined threshold value.

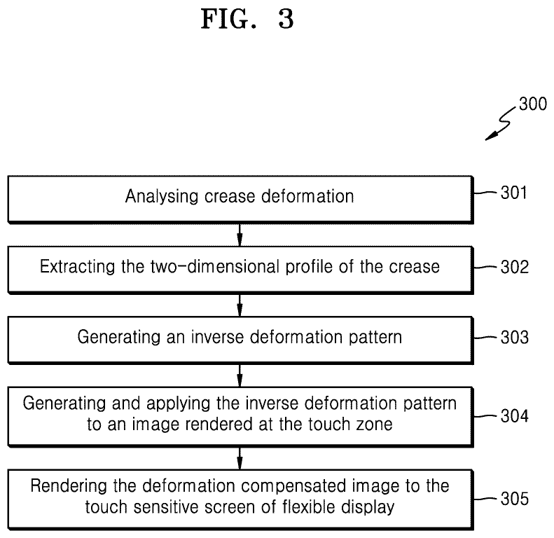

FIG. 3 illustrates a flowchart of a method 300 of applying a deformation compensation to an image displayed, to reduce a visual artifact near a deformed region of the flexible display by the screen-deformation correction unit 203, according to an embodiment of the disclosure. The method 300 may comprise the operations of analyzing crease deformation in operation 301.

In operation 302, a two-dimensional profile of a crease is extracted. In operation 303, an inverse deformation pattern may be generated and in operation 304, the inverse deformation pattern may be generated and applied to an image rendered at the flexible display. Further, in operation 305, a deformation compensated image may be rendered to the flexible display.

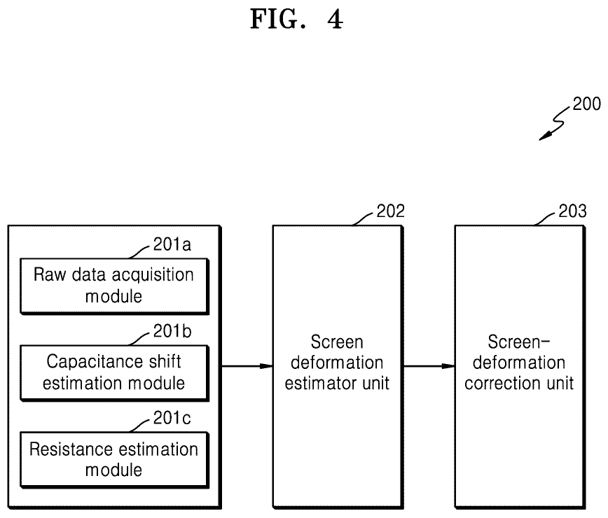

FIG. 4 illustrates a block diagram of a system 200 for determining a status of a flexible screen, according to an embodiment of the disclosure. The system 200 may comprise a raw data acquisition module 201a for interpreting and pre-processing a raw value of a touch sensitive screen of a flexible display for generating a baseline value. In an embodiment, the raw value of the touch sensitive screen of the flexible display may include capacitance, inductance, and/or resistance values and a change in the capacitance value may be due to deformation in X, Y and Z directions. The system 200 may be understood as an example of an apparatus for determining a status of a flexible display according to an embodiment of the disclosure.

Further, the system 200 may comprise a capacitance shift estimation module 201b for calculating a variation in the capacitance value from the baseline value. Further, the system 200 may comprise a resistance estimation module 201c for calculating a change in an electrical resistance of a receiver and a change in an electrical resistance of a transmitter electrode.

Furthermore, the system 200 may comprise a screen deformation estimator unit 202 for analyzing a variation in a capacitance, inductance, and/or resistance value over a pre-defined period of time to identify an affected pixel of the flexible display. Further, the system 200 may comprise a screen-deformation correction unit 203 for analyzing a screen topology for determining at least one deformation for the affected one or more pixels based on the pre-defined threshold.

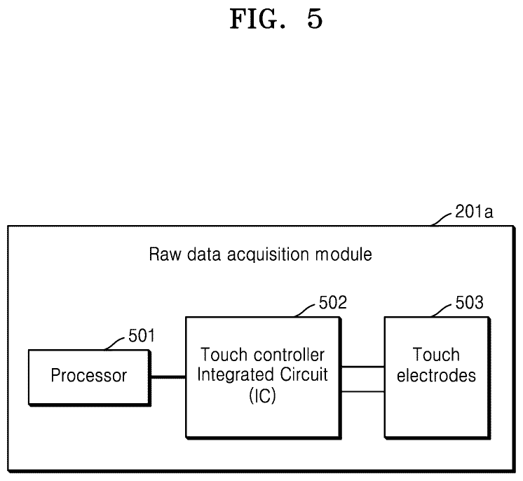

FIG. 5 illustrates a block diagram of the raw data acquisition module 201a, according to an embodiment of the disclosure. The raw data acquisition module 201a may comprise a processor 501, more particularly, a host processor for communicating with a touch controller Integrated Circuit (IC) 502 and sending a request for reading the raw values of capacitance from a plurality of touch electrodes 503. In an embodiment, the processor 501 may communicate with the touch controller integrated circuit 502 through half duplex communication such as Inter-Integrated Circuit (IIC/12C) or full duplex communication such as Serial Peripheral interface (SPI).

In an embodiment, a system for determining a status of a flexible screen may include the processor 501 and a memory which stores a plurality of instructions. The plurality of instructions, upon execution by the processor 501, may cause the processor 501 to extract a baseline value of the capacitance, inductance, and/or resistance value. Further, the plurality of instructions, upon execution by the processor 501, may cause the processor 501 to calculate the variation in the value(s). The system 200 may be coupled to a database via a communication network. Examples of devices having a touch sensitive flexible display may include, but are not limited to, a laptop, a tablet, a smartphone, a mobile phone, or the like.

The processor 501 may include appropriate logic, circuitry, interfaces, and/or code that may be configured to automatically manage a plurality of baseline values related to the display screen. The processor 501 may be implemented based on a variety of processor technologies, which may be known to one ordinarily skilled in the art. Examples of implementations of the processor 501 may include, for example but not limited to, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, an Artificial Intelligence (AI) accelerator chip, a co-processor, a central processing unit (CPU), and/or a combination thereof.

The memory may also store various data (for example, baseline values, updated values of various parameters related with the screen and the like) that may be captured, processed, and/or required by the system 200. The memory may be a non-volatile memory or a volatile memory. Examples of the non-volatile memory may include, but are not limited to, a flash memory, a Read-Only Memory (ROM), a Programmable ROM (PROM), Erasable PROM (EPROM), and Electrically EPROM (EEPROM) memory. Examples of volatile memory may include, but are not limited to, Dynamic Random-Access Memory (DRAM), and Static Random-Access memory (SRAM).

In an embodiment, the capacitance shift estimation module 201b may be configured to receive the capacitance value from the integrated circuit 502 of the touch sensitive display of the flexible screen and may calculate the variation in the capacitance value from the baseline value, wherein the baseline value of the capacitance is stored in the memory. Values of capacitances may be calculated and updated periodically by the touch sensitive screen of the flexible display.

In an embodiment, the resistance estimation module 201c may be responsible for calculating changes in the electrical resistance values of a receiver electrode and a transmitter electrode. The resistance changes of the receiver and the transmitter electrodes may be calculated by calculating a Resistance Capacitance (RC) time constant change by using the following equation:

$$τ = R \times C$$

wherein τ is the time constant in seconds of an RC circuit, R is a resistance of the circuit and C is a capacitance of the circuit. The time constant for each of the receiver and transmitter electrodes may be evaluated using the following equations:

$${τ}_{touched TX} = {R}_{TX} ( {C}_{m}^{′} + {C}_{fTX} )$$

$${τ}_{touched RX} = {R}_{RX} ( {C}_{m}^{′} + {C}_{fRX} )$$

$${τ}_{untouched TX} = {R}_{TX} ( {C}_{m} + {C}_{pTX} )$$

$${τ}_{untouched RX} = {R}_{RX} ( {C}_{m} + {C}_{pRX} )$$

wherein RTX is the resistance of the transmitter electrode, RRX is the resistance of the receiver electrode, C′m is a parasitic capacitance of electrode, C_{fTX} and C_{fRX} are touched equivalent capacitances and C_{pTX}and C_{pRX} are untouched equivalent capacitances.

In an embodiment, the resistances of the transmitter and receiver electrodes may be obtained by the following equation:

$${R}_{electrode} = {R}_{s} \times ( L / W )$$

$$wherein , {R}_{s} = ρ / t$$

Rₛ is resistance of a sheet, P is a bulk resistivity of the sheet, t is a thickness of the sheet, L is a length of the electrode and W is a width of the electrode.

In an embodiment, the operation 102 of calculating the variation in the resistance value may comprise operations such as reading a three-dimensional (3D) resistance drift and/or a variation with respect to a number of bends and a temperature. The operation 102 may further comprise reading a current temperature and a number of bends for the screen from one or more sensors and a storage. Furthermore, the operation 102 may comprise determining a drift matrix for each electrode.

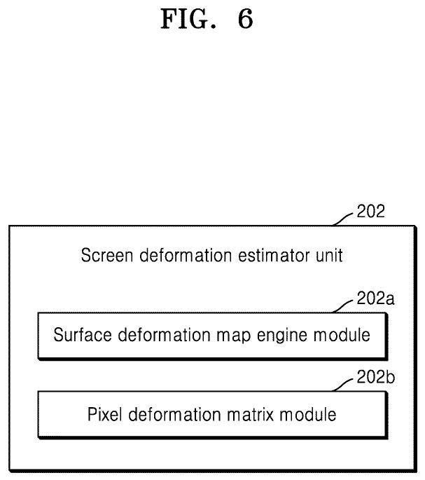

FIG. 6 illustrates a block diagram of the screen deformation estimator unit 202, according to an embodiment of the disclosure. The screen deformation estimator unit 202 may comprise a surface deformation map engine module 202a for determining a change in a bridge gap between a plurality of electrodes and generating a surface deformation map. Further, the screen deformation estimator unit 202 may comprise a pixel deformation matrix module 202b for creating a power profile of a pixel, calculating a change in power consumption of a group of pixels corresponding to each touch sensor node of the plurality of electrodes, determining a change in the resistance value of the electrode due to deformation and formation of a pixel deformation matrix. In an embodiment, the change in the bridge gap between the plurality of electrodes may be determined using the equation 1:

$${D}_{C} = {ℰ}_{touch} ( {A}_{elevtrode} / {C}_{shift} ) \qquad ( equation 1 )$$

wherein DC is a surface deformation matrix, ε_{touch} is a dielectric constant for an interface material of the touch screen, Aelectrode is an area of a sheet of an electrode junction and C_{shift} is a mutual capacitance shift calculated for the transmitter and receiver electrodes. In an embodiment, an apparatus for determining a status of a flexible display (e.g., the system 200 in FIG. 4) may obtain capacitance data as output of the resistance estimation module 201c. The apparatus may obtain a capacitance shift matrix from the output of the resistance estimation module 201c. The apparatus may obtain the surface deformation matrix by surface deformation estimation according to the above equation 1. In an embodiment, an operation of creating the power profile of the pixel may comprise operations of generating images based on a number and a location of electrodes. In an embodiment, standard power images for generating images based on the number and the location of electrodes may be retrieved from the storage. Further, the operation of creating the power profile of the pixel may comprise displaying power images for all pixel groups. Further, the operation of creating the power profile of the pixel may comprise measuring power for all images of all the pixel groups. Furthermore, the operation of creating the power profile of the pixel may comprise creating a matrix for mapping with capacitance locations or power for each pixel.

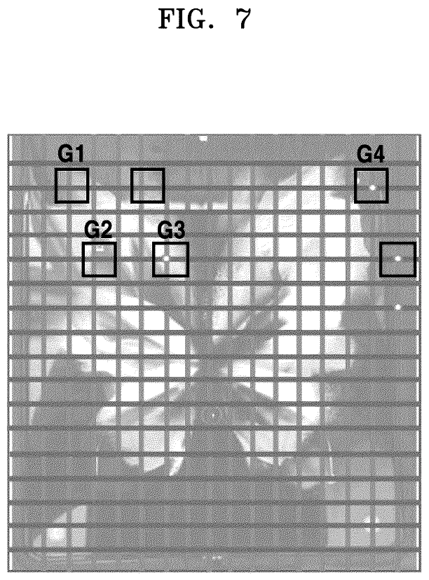

In an embodiment, an electronic display panel is shown as an example in FIG. 7, having an active-matrix area or a pixel array in which an array of pixels are arranged in a row and column configuration. In an embodiment, the apparatus may calculate current consumed by the display based on a number of pixels which that are “ON”. Therefore, the current in a black image may be zero, and current in a white image may be maximum current. In an embodiment, the operation for calculating the power profile (or pixel power consumption profile) may comprise grouping pixels into blocks corresponding to each touch electrode node, for example, G1, G2, G3, and G4. Further, specific images with only one group of pixels activated may be displayed, such as G1 group of pixels activated for Red, Green, Blue (R, G, B) pixels separately. Further, current drawn by a power management module of the apparatus (e.g., system 200) may be measured. Subsequently, above-described operations may be repeated for all required groups of pixels to be tested. Furthermore, total power consumed by any group of pixels may be calculated such as total power (P=Pr+Pg+Pb), In an embodiment, the apparatus may identify the pixel defect based on the variation of the raw value(s) corresponding to each pixel being greater than the pre-defined threshold value. The pre-defined threshold value may be associated with a power value.

In an embodiment, an operation of formation of the pixel deformation matrix may comprise obtaining the surface deformation map from the surface deformation map engine module 202a. A change in the resistance value of the electrode due to deformation may be obtained subsequent to obtaining the power profile of the pixel. The formation of the pixel deformation matrix may be based on a matrix concatenation operation. In an embodiment, the matrix concatenation operation may be an operation to join two sub matrices horizontally and/or vertically into one matrix. In an embodiment, the apparatus may identify the pixel defect based on the variation of the raw value(s) corresponding to each pixel being greater than the pre-defined threshold value.

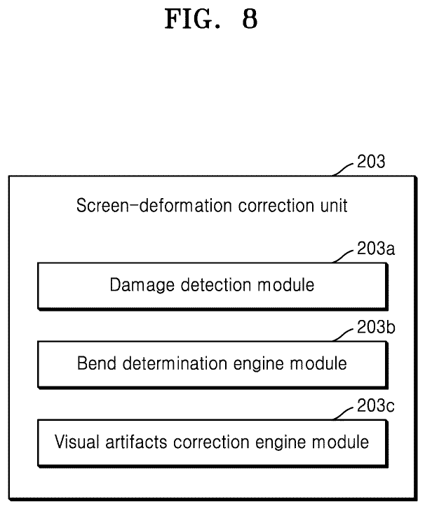

FIG. 8 illustrates a block diagram of the screen-deformation correction unit 203, according to an embodiment of the disclosure. The screen-deformation correction unit 203 may comprise a damage detection module 203a for classifying a pixel damage using pre-defined threshold(s). The damage detection module may analyze the pixel deformation matrix, calculate pixel power consumption, analyze a change in the electrode resistance, and identify a damage type. The screen-deformation correction unit 203 may comprise a bend determination engine module 203b for estimating a bend angle of the flexible display, analyzing crease deformation, and a calculating panel to panel distance. The screen-deformation correction unit 203 may comprise a visual artifacts correction engine module 203c for analyzing crease deformation, extracting deformation profile, generating and applying an inverse deformation effect and rendering a compensated image to eliminate or reduce visual artifacts.

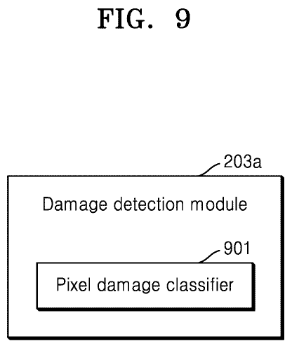

FIG. 9 illustrates a functional block diagram of the damage detection module 203a, according to an embodiment of the disclosure. The damage detection module 203a may be configured to receive the deformation matrix and further extract the deformation matrix for determining the pixel location corresponding to the deformation identified/detected. Further, the damage detection module 203a may comprise a pixel damage classifier 901 for classifying damage detected. For example, the damage may be classified into the following damage types. In a first case, if the deformation identified is greater than threshold deformation, damage identified for a touch electrode is greater than a threshold damage for the touch electrode, and power calculated is greater than a threshold power, the pixel and a touch point may be classified as damaged. In a second case, if the deformation identified is greater than the threshold deformation, and power calculated is greater than the threshold power, pixels may be worn out and some possible failure in future may be predicted. In a third case, if deformation identified for the touch electrode is greater than the threshold deformation for the touch electrode, the touch electrode may be worn out, and possible touch issue in future may be predicted. Meanwhile, the variation may be used to identify affected one or more pixels that are affected without causing a visible change to the flexible display. Each case described above is only an example, and is not limited thereto.

In one embodiment, the bend determination engine module 203b may be configured to receive the deformation matrix. Further, the bend determination engine module 203b may extract a crease part from the deformation matrix. The bend determination engine module 203b may generate a two-dimensional profile of the crease deformation and estimate a valley or an angle from the two-dimensional profile of the crease deformation. The bend determination engine module 203b may be responsible for calculating the panel-to-panel angle and estimating the bend angle of the flexible screen. In an embodiment, the panel-to-panel angle may be calculated using capacitive or inductive sensing structure.

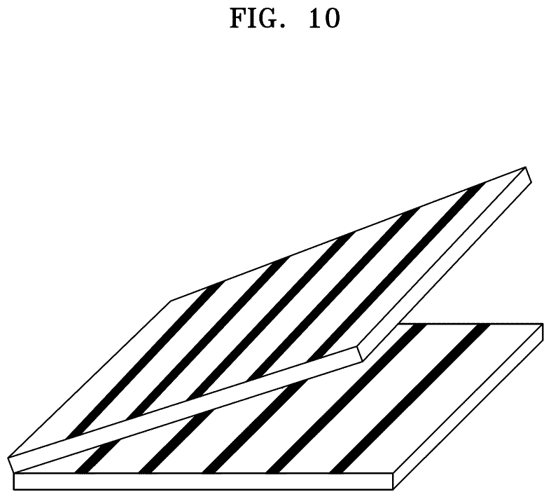

FIG. 10 illustrates a diagram showing an upper panel and a lower panel of the flexible display according to an embodiment of the disclosure. In an embodiment, the operation of calculating the panel-to-panel electrode angle may comprise the operations of configuring the electrodes in the two planes as transmitters and receivers. Further, mutual capacitance or inductance of the electrodes in a bend condition and a distance between parallel electrodes on two planes of the panel may be estimated. The apparatus (e.g., system 200 in FIG. 4) may estimate the bend angle. In an embodiment, when the screen is folded making an obtuse angle between the two panels of the screen, then adjacent electrodes are out of a maximum distance range.

In an embodiment, the method of determining a status of a flexible screen may comprise applying a deformation compensation to the image displayed, to reduce a visual artifact near the deformed region of the flexible display by the screen-deformation correction unit 203, which may further comprise operations of analyzing crease deformation, extracting the two-dimensional profile of the crease, generating an inverse deformation pattern, generating and applying the inverse deformation pattern to an image rendered at the flexible display and rendering the deformation compensated image to the flexible display. In an embodiment, the apparatus may determine an angle between two planes of the flexible display or valley formation of the flexible display according to the variation. The apparatus may determine crease line identification or bend detection based on the angle or valley formation.

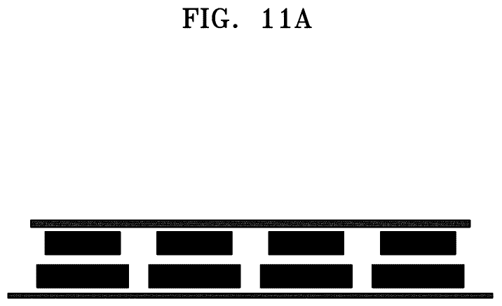

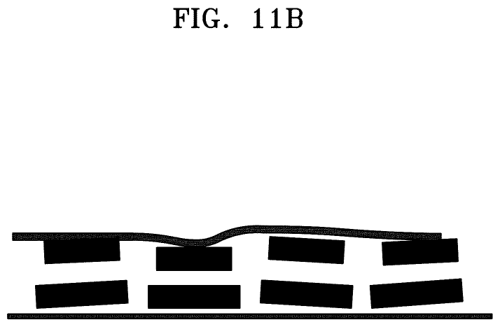

FIG. 11A and 11B illustrate a non-deformed screen and a deformed screen.

In an embodiment, FIG. 11A illustrates a cross section of the non-deformed screen. The non-deformed screen does not have any affected pixel. The capacitance between all electrodes in the non-deformed screen may be consistent. In an embodiment, FIG. 11B illustrates a cross section of the deformed screen. The deformed screen has affected one or more pixels. More particularly, there is a change in the capacitance value due to deformation in X-Y and Z directions. In an embodiment, the screen may include three layers, which may be top flexible glass coating, electrodes that forms a middle layer of the screen, and a polymer substrate such as polyethylene terephthalate (PET) that forms a bottom layer of the screen. In an embodiment, the apparatus may obtain surface deformation matrix by using the capacitance value in the same or similar way as described for FIG. 6.

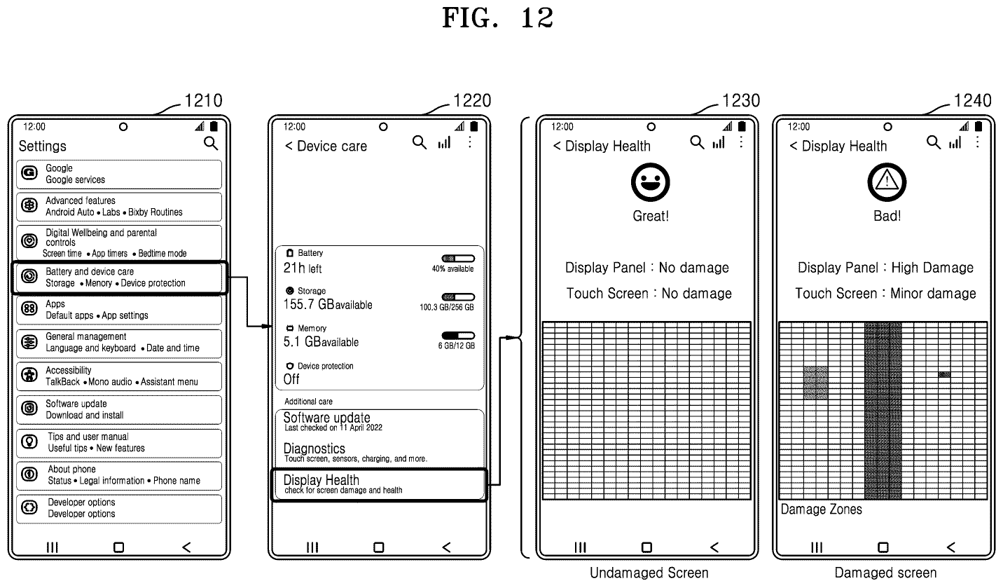

Referring to FIG. 12, diagrams for describing operations of the flexible display according to an embodiment of the disclosure are illustrated. In an embodiment, a screen health and damage monitoring may be easily viewed by the user, e.g., for an undamaged screen, “GREAT” may be displayed on a screen 1230 and for a damaged screen “BAD” may be displayed on a screen 1240.

In an embodiment, the apparatus may obtain a request for information associated with the screen health and the damage monitoring of the flexible display. A screen 1210 and a screen 1220 may be an example of obtaining the request for the information associated with the screen health or the damage monitoring of the flexible display. The apparatus may provide the status of the flexible display. If the flexible display has deformation, the apparatus may provide the status of the flexible display as having deformation through the screen 1230 or the screen 1240, in response to a request from the user for the information associated with the screen health or damage monitoring of the flexible display. The screen 1240 may include a degree of a damage to a display panel or a touch screen and a location of a damaged zone. The screens 1210-1240 shown in FIG. 12 are merely examples, and the displayed screens are not limited thereto.

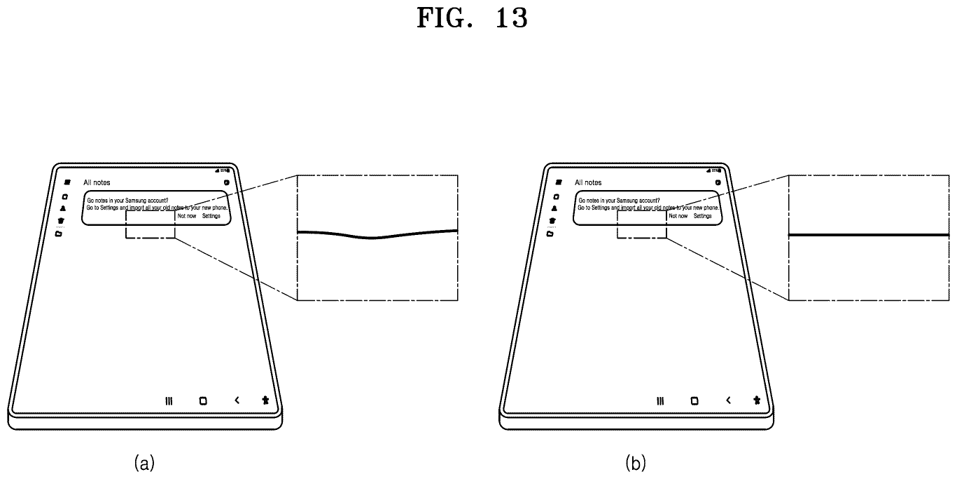

FIG. 13 illustrates an example of a use case of a flexible display according to an embodiment of the disclosure. Referring to FIG. 13, consider an image taken by a flexible device. In (a) of FIG. 13, in which the method according to an embodiment is not applied, a line, intended to be a straight line, is shown uneven due to deformation of one or more pixels. In (b) of FIG. 13, in which the method according to an embodiment is applied, the straight line is shown straight because of the application of the visual compensation for artifacts which are caused due to screen deformation.

In an embodiment, where there is a crease line, a capacitance change may be observed. For visual artifact correction, the apparatus may receive the deformation matrix, and then, identify a crease location by using the deformation matrix. The deformation matrix may be derived as a geometric transformation for pixel shift. The apparatus may extract a 2D profile of crease. The apparatus may generate and apply warping effect to the image using the 2D profile of crease based on an orientation and an image frame to be displayed. In other words, the apparatus may generate an inverse deformation pattern based on identifying image inversion. Next, the apparatus may obtain a deformation compensated image based on the inverse deformation pattern. The apparatus may provide the deformation compensated image through the flexible display. The displayed image may be inverse deformed.

The disclosure provides the method 100 for determining health of a flexible touch screen display. According to the method 100, the user may locate flaws or indentations on a screen. Additionally, the method 100 may predict potential screen failure and provide users an option to schedule data backup, thus allowing the users to tailor screen replacements according to needs of different user types without use of additional sensors. Furthermore, the disclosure offers the method 100 for determining the folding angle for a device.

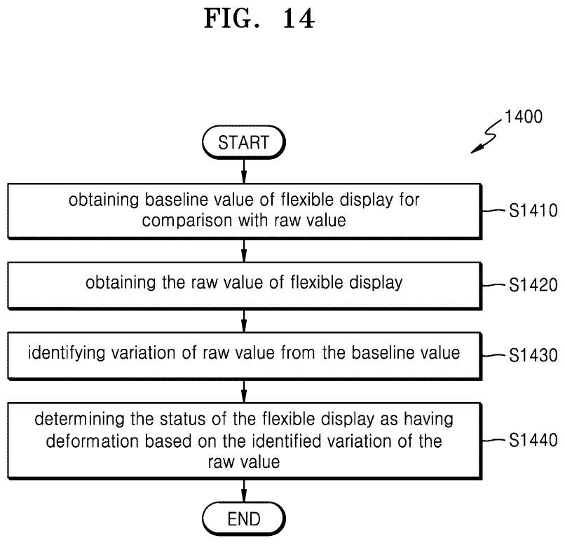

FIG. 14 illustrates a flow chart of a method 1400 for determining a status of a flexible display according to an embodiment of the disclosure.

At operation S1410, an apparatus for performing the method 1400 may obtain a baseline value of the flexible display for comparison with a corresponding raw value. In an embodiment, the apparatus may obtain the baseline value including at least one of capacitance, inductance, resistance, and power values of the flexible display. The baseline value may be a value determined by experiment, may be a measured raw value(s) at first time point.

At operation S1420, the apparatus may obtain the raw value of the flexible display. The apparatus may obtain the raw value indicating the status of the flexible display at second time point. The second time point may be a time point after the first time point, and may be different from the first time point. The raw value may also include at least one of capacitance, inductance, resistance, and power values of the flexible display.

At operation S1430, the apparatus may identify a variation of the raw value from the corresponding baseline value. In an embodiment, the apparatus may identify that a difference between the raw value and the baseline value is greater than or equal to the threshold value.

At operation S1440, the apparatus may determine the status of the flexible display as having deformation based on the identified variation of the raw value. Based on the difference, the apparatus may determine the flexible display have deformation. The deformation may include at least one of pixel defect, crease line, bend detection, and image inversion. The deformation is not limited to the disclosed example as long as it can be identified using variation or difference in capacitor, inductor, resistance, and/or power values. Meanwhile, since the way for identifying the deformation has been described in detail above, it will be omitted.

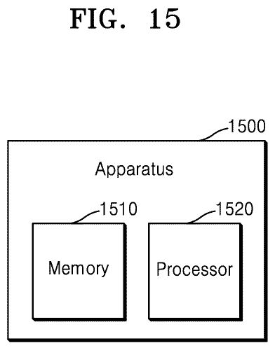

FIG. 15 illustrates a block diagram of an apparatus for implementing an embodiment of the disclosure.

In an embodiment, the apparatus for determining a status of a flexible display may include a memory 1510 and at least one processor 1520. The memory 1510 may store an application program executable by the at least one processor 1520 to cause the at least one processor to perform at least one operation of the method described above. In embodiments, a system or an apparatus with a storage medium may be provided. Software program codes capable of implementing the functions of any one of the above embodiments are stored in the storage medium, capable of making a computer (or a central processing unit (CPU) or a microprocessor unit (MPU)) of the system or apparatus read out and execute the program codes stored in the storage medium. Furthermore, some or all of actual operations may be completed by an operating system or the like running in the computer through instructions based on the program codes. The program codes read out from the storage medium may be written into a memory provided in an extension board inserted into the computer or into a memory provided in an extension unit connected to the computer. Then, an instruction based on the program codes causes a CPU or the like installed on the extension board or the extension unit to perform some or all of the actual operations, to realize the functions of any one of the embodiments of the above method.

In an embodiment, the memory 1510 may be implemented by various storage media such as an electrically erasable programmable read-only memory (EEPROM), a flash memory, and a programmable program read-only memory (PROM). The at least one processor 120 may be implemented to include one or multiple central processing units or one or multiple field programmable gate arrays. The field programmable gate arrays are integrated with one or multiple central processing unit cores. In embodiments, the central processing unit or central processing unit core may be implemented as a CPU or an MCU.

In an embodiment, the at least one processor 1520 may be operable to perform operations according to the above example embodiment(s). The at least one processor 120 may perform operation performed by at least one of the raw data acquisition module 201a, the capacitance shift estimation module 201b, the resistance estimation module 201c, the screen deformation estimator unit 202, the surface deformation map engine module 202a, the pixel deformation matrix module 202b, the screen-deformation correction unit 203, the damage detection module 203a, the bend determination engine module 203b, and the visual artifacts correction engine module 203c. Detailed descriptions are omitted because they are redundant.

In an embodiment of the disclosure, at least one processor 1520 may control the overall operation of the other components included in the apparatus.

In an embodiment the disclosure, the modules and the units may be such that operations performed by at least one processor are classified in the modules and the units according to functions or purposes, and may refer to software modules. Of course, each module or each unit may be implemented in independent hardware.

In an embodiment, the disclosure, operations performed by modules and units may actually be performed by a processor of a server.

In an embodiment of the disclosure, the method may include pertaining to analyzing and processing the existing display modules deployed in products to extract information of deformation or the defect that has occurred due to the wear and repeated use or folding of the screen.

In an embodiment of the disclosure, when bending occurs in a flexible screen, the touch screen carried in a module is subjected to deformation accordingly with the result that the capacitance changes. Through the acquisition of the data concerning the capacitance change to determine the bending degree of the flexible screen, it is possible to accurately determine whether the flexible screen is subjected to bending or excessive bending without increasing a thickness of a flexible screen module, therefore, thereby improving the user's use experience. In addition, in an embodiment of the disclosure, a deformation compensation may be applied to the image displayed to reduce visual artifact near the deformed region of the flexible display.

In an embodiment of the disclosure, the method may include determining deformation for the affected pixel based on a pre-defined threshold and may include applying deformation compensation for the affected pixel to reduce visual artifact near the deformed region of the flexible display.

In an embodiment of the disclosure, the method may include analyzing and processing the screen topology based on the pre-defined threshold for determining deformation, or the defect that has occurred due to the wear and repeated use or folding of the screen.

Hence, there exists a need for detecting deformation on the screen and providing a visual compensation to reduce deformation visibility to the user.

In an embodiment, a method for determining a status of a flexible display is provided. The method 100 may comprise operations of interpreting and pre-processing a raw value of a touch sensitive screen of a flexible display for generating a baseline value by a raw data acquisition module 201a, calculating a variation of the raw value from the baseline value by a capacitance shift estimation module 201b and a resistance estimation module 201c, analyzing a variation in capacitance, inductance, and/or resistance values over a pre-defined period of time by a screen deformation estimator unit 202 to identify affected one or more pixels of the flexible display, analyzing a screen topology for determining at least one deformation for the affected one or more pixels based on pre-defined threshold by a screen-deformation correction unit 203.

In an embodiment, the raw value of the touch sensitive screen of the flexible display may include a capacitance, inductance, and/or resistance value.

In an embodiment, the variation of the capacitance, inductance and/or resistance value from the baseline values may arise due to a change in the mechanical property in a surface of the touch sensitive screen of the flexible display.

In an embodiment, the screen topology may be analyzed for determining an arc angle or valley formation across the surface of the touch sensitive screen of the flexible display for the affected one or more pixels.

In an embodiment, the change in the baseline capacitance and inductance may be detected to analyze and estimate the health of the pixel structure, power profile of pixels, flexible display screen, etc. and inform a user of the screen's potential failure.

In an embodiment, the screen topology may be analyzed for determining at least one of a deformation for bending detection/calculation, image inversion and pixel defect for the identified affected one or more pixels.

In an embodiment, the affected one or more pixels may be determined to detect at least one of a point, an area or a zone for the number of pixels with a variation in a capacitance, inductance, and/or resistance value exceeding a predetermined threshold in comparison to the normal surface.

In an embodiment, the affected one or more pixels may be classified based on the pre-defined threshold by a damage detection module 203a of the screen-deformation correction unit 203.

In an embodiment, the variation in the capacitance, inductance, and/or resistance value may be analyzed over a pre-defined period of time to identify one or more touch screen pixels that are affected without causing a visible change to the touch sensitive screen of the flexible display.

In an embodiment, the deformation compensation may be applied for the affected one or more pixels to an image displayed, to reduce visual artifact near the deformed region of the flexible display by the visual artifacts correction engine module (203c) of the screen-deformation correction unit 203.

In an embodiment, the method may include retrieving a threshold value for change for pixel damage of the touch sensitive screen of the flexible display from storage. The method may include calculating change in the pre-determined threshold for the capacitance, inductance, resistance and power consumption value for each pixel point. The method may include identifying the pixel structure as damaged, if change is above or matches with the threshold.

In an embodiment, the method may include analyzing crease deformation. The method may include extracting the two-dimensional profile of the crease. The method may include generating an inverse deformation pattern. The method may include generating and applying the inverse deformation pattern to an image rendered at the flexible display. The method may include rendering the deformation compensated image to the flexible display.

In an embodiment, a system for determining a status of a flexible screen. The system may include a raw data acquisition module 201a for interpreting and pre-processing raw values of a touch sensitive screen of a flexible display for generating baseline values. The system may include a capacitance shift estimation module 201b for calculating variation in the capacitance value from baseline value. The system may include a resistance estimation module 201c for calculating electrical resistance change of a receiver and a transmitter electrode. The system may include a screen deformation estimator unit 202 for analyzing the variation in the capacitance, inductance, and/or resistance value over a pre-defined period of time to identify affected one or more pixels of the flexible display. The system may include a screen-deformation correction unit 203 for analyzing a screen topology.

In an embodiment, the screen deformation estimator unit 202 may comprise a surface deformation map engine module 202a for determining a change in a bridge gap between a plurality of electrodes and generating a surface deformation map. The screen deformation estimator unit 202 may comprise a pixel deformation matrix module 202b for creating a power profile of pixel, calculating change in power consumption of group of pixels corresponding to each touch sensor node of the plurality of electrodes, determining change in the resistance value of the electrode due to deformation and formation of a pixel deformation matrix.

In an embodiment, the screen-deformation correction unit 203 may comprise a damage detection module 203a for classifying a pixel damage using pre-defined thresholds. The screen-deformation correction unit 203 may comprise a bend determination engine module 203b for estimating a bend angle of the flexible display. The screen-deformation correction unit 203 may comprise a visual artifacts correction engine module 203c for generating and applying an inverse deformation effect and further rendering compensated image to eliminate or reduce visual artifacts.

In an embodiment, a method for determining status of flexible display is provided. The method may include obtaining baseline values of flexible display for comparison with raw values. The method may include obtaining the raw values of flexible display. The method may include identifying variation of raw values from the baseline values. The method may include determining the status of the flexible display as having deformation based on the identified variation of the raw values.

In an embodiment, the raw values of the flexible display and the baseline values may include at least one of capacitance, inductance, resistance values, and power consumption values.

In an embodiment, the deformation includes at least one of pixel defect, crease line, bend detection, and image inversion.

In an embodiment, the method may include determining angle between two plane of the flexible display, or valley formation of the flexible display according to the variation. The method may include determining crease line identification or bend detection based on the angle or valley formation.

In an embodiment, the method may include generating inverse deformation pattern based on identifying the image inversion. The method may include obtaining deformation compensated image based on the inverse deformation pattern. The method may include providing the deformation compensated image through the flexible display.

In an embodiment, the method may include identifying the pixel defect based on the variation of the raw value corresponding to each pixel being greater than the pre-defined threshold value.

In an embodiment, the variation may be used to identify the affected one or more pixels that are affected without causing a visible change to flexible display.

In an embodiment, providing the status of the flexible display as having the deformation corresponding to user input for requesting the information associated with the screen health or damage monitoring of the flexible display.

In an embodiment, an apparatus for determining status of flexible display is provided. The apparatus may comprise a memory configured to store instructions, and at least one processor configured to execute the instructions. The at least one processor may be configured to obtain baseline values of flexible display for comparison with raw values. The at least one processor may be configured to obtain the raw values of flexible display. The at least one processor may be configured to identify variation of raw values from the baseline values. The at least one processor may be configured to determine the status of the flexible display as having deformation based on the identified variation of the raw values.

In an embodiment, the raw values of the flexible display and the baseline values may include at least one of capacitance, inductance, resistance values, and power consumption values.

In an embodiment, the deformation may include at least one of pixel defect, crease line, bend detection, and image inversion.

In an embodiment, the at least one processor is configured to determine angle between two plane of the flexible display, or valley formation of the flexible display according to the variation. The at least one processor may be configured to determine crease line identification or bend detection based on the angle or valley formation.

In an embodiment, the at least one processor may be configured to generate inverse deformation pattern based on identifying the image inversion. The at least one processor may be configured to obtain deformation compensated image based on the inverse deformation pattern. The at least one processor may be configured to provide the deformation compensated image through the flexible display.

In an embodiment, the at least one processor is configured to identify the pixel defect based on the variation of the raw value corresponding to each pixel being greater than the pre-defined threshold value.

In an embodiment, a computer-readable storage medium, storing instructions for executing the method for determining status of flexible display is provided. The method may include obtaining at least one baseline value of a flexible display for comparison with at least one raw value. The method may include obtaining the at least one raw value of the flexible display. The method may include identifying a variation of the at least one raw value from the at least one baseline value. The method may include determining the status of the flexible display as having deformation based on the identified variation of the at least one raw value.

At least one of the components, elements, modules or units (collectively “components” in this paragraph) described in the specification and/or represented in the drawings, may be embodied as various numbers of hardware, software and/or firmware structures that execute respective functions described above, according to an example embodiment. For example, at least one of these components may use a direct circuit structure or circuitry, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU) that performs the respective functions, a microprocessor, or the like. Two or more of these components may be combined into one single component which performs all operations or functions of the combined two or more components. Also, at least part of functions of at least one of these components may be performed by another of these components. Further, communication between the components may be performed through a bus. Functional aspects of the above example embodiments may be implemented in algorithms that execute on one or more processors. Furthermore, the components or processing steps may employ any number of related art techniques for electronics configuration, signal processing and/or control, data processing and the like.

The scope of the present disclosure is not defined by the detailed description of the present disclosure but by the following claims, and all modifications or alternatives derived from the scope and spirit of the claims and equivalents thereof fall within the scope of the present disclosure.

What is claimed is:

1. A method for determining a status of a flexible display, the method comprising:
obtaining at least one baseline value of the flexible display;
obtaining at least one raw value of the flexible display;
identifying a variation of the at least one raw value from the at least one baseline value; and
determining the status of the flexible display as having deformation based on the identified variation of the at least one raw value.

2. The method of claim 1, wherein each of the at least one raw value and the at least one baseline value include at least one of a capacitance value, an inductance value, a resistance value, and a power consumption value.

3. The method of claim 1, wherein the deformation includes at least one of a pixel defect, a crease line identification, a bend detection, and an image inversion.

4. The method of claim 3, wherein the determining the status of the flexible display as having the deformation comprising:
determining an angle between a first plane and a second plane of the flexible display or a valley formation of the flexible display, based on the variation; and
determining the crease line identification or the bend detection based on the angle or the valley formation.

5. The method of claim 3, further comprising:
generating an inverse deformation pattern based on identifying the image inversion;
obtaining a deformation compensated image based on the inverse deformation pattern; and
providing the deformation compensated image through the flexible display.

6. The method of claim 5, wherein the generating the inverse deformation pattern comprises:
analyzing crease deformation, and extracting two-dimensional profile of a crease; and
generating the inverse deformation pattern based on the extracted two-dimensional profile of the crease.

7. The method of claim 3, wherein the determining the status of the flexible display as having the deformation comprising:
identifying the pixel defect based on the variation of the at least one raw value corresponding to each pixel being greater than a pre-defined threshold value.

8. The method of claim 1, further comprising:
identifying, based on the identified variation, affected one or more pixels that are affected by the deformation without causing a visible change to the flexible display.

9. The method of claim 1, further comprising:
providing the status of the flexible display as having the deformation in response to a request from a user for information associated with at least one of a screen health or a damage monitoring of the flexible display.

10. The method of claim 9, wherein the providing the status of the flexible display has having the deformation includes displaying, on a screen, an indicator indicating at least one of a degree of a damage to a display panel of the flexible display and a location of a damaged area of the display panel.

11. An apparatus for determining a status of a flexible display, comprising:
a memory configured to store one or more instructions; and
at least one processor configured to execute the one or more instructions to:
obtain at least one baseline value of the flexible display;
obtain at least one raw value of the flexible display;
identify a variation of the at least one raw value from the at least one baseline value; and
determine the status of the flexible display as having deformation based on the identified variation of the at least one raw value.

12. The apparatus of claim 11, wherein each of the at least one raw value of the flexible display and the at least one baseline value includes at least one of a capacitance value, an inductance value, a resistance value, and a power consumption value.

13. The apparatus of claim 11, wherein the deformation includes at least one of a pixel defect, a crease line identification, a bend detection, and an image inversion.

14. The apparatus of claim 13, wherein the at least one processor is configured to execute the one or more instructions to:
determine an angle between a first plane and a second plane of the flexible display or a valley formation of the flexible display based on the variation; and
determine the crease line identification or the bend detection based on the angle or the valley formation.

15. The apparatus of claim 13, wherein the at least one processor is configured to execute the one or more instructions to:
generate an inverse deformation pattern based on identifying the image inversion;
obtain a deformation compensated image based on the inverse deformation pattern; and
provide the deformation compensated image through the flexible display.

16. The apparatus of claim 15, wherein the at least one processor is configured to execute the one or more instructions to:
analyze crease deformation, and extracting two-dimensional profile of a crease; and
generate the inverse deformation pattern based on the extracted two-dimensional profile of the crease.

17. The apparatus of claim 13, wherein the at least one processor is configured to execute the one or more instructions to:
identify the pixel defect based on the variation of the at least one raw value corresponding to each pixel being greater than a pre-defined threshold value.

18. The apparatus of claim 11, wherein the at least one processor is configured to execute the one or more instructions to:
identify, based on the identified variation, affected one or more pixels that are affected by the deformation without causing a visible change to the flexible display.

19. The apparatus of claim 11, wherein the at least one processor is configured to execute the one or more instructions to:
provide the status of the flexible display as having the deformation in response to a request from a user for information associated with at least one of a screen health or a damage monitoring of the flexible display.

20. A non-transitory computer-readable storage medium, storing one or more instructions executable by at least one processor to perform:
obtaining at least one baseline value of a flexible display;
obtaining at least one raw value of the flexible display;
identifying a variation of the at least one raw value from the at least one baseline value; and
determining a status of the flexible display as having deformation based on the identified variation of the at least one raw value.
